(19) United States
(12) Patent Application Publication
(10) Pub. No.: US 2024/0247111 A1
(43) Pub. Date: Jul. 25, 2024

(54) SOL-GEL SYNTHESIS OF PHOSPHOROUS-CONTAINING MAX PHASE V2PC

(71) Applicants: Christina S. Birkel, Tempe, AZ (US); Jordan Sinclair, Tempe, AZ (US); Jan P. Siebert, Darmstadt (DE)

(72) Inventors: Christina S. Birkel, Tempe, AZ (US); Jordan Sinclair, Tempe, AZ (US); Jan P. Siebert, Darmstadt (DE)

(21) Appl. No.: 18/421,880

(22) Filed: Jan. 24, 2024

Related U.S. Application Data
(60) Provisional application No. 63/481,269, filed on Jan. 24, 2023.

(51) Int. Cl. C08J 3/075; C01G 31/00

(52) U.S. Cl. CPC C08J 3/075; C01G 31/006; C08J 2303/02; C08J 2303/08; C08J 2305/08

(57) ABSTRACT

Making a MAX phase material having a composition represented by V₂PC includes combining a transition metal component, a phosphorus component, and a carbon component to yield a mixture, heating the mixture to yield a gel, and heating the gel to yield the MAX phase material. wherein the MAX material has a composition represented by V₂PC. The transition metal component includes vanadium, the phosphorus component includes phosphoric acid, and the carbon component includes an organic compound. The MAX phase material can be in the form of a film, microsphere, or microwire.

### CROSS-REFERENCE TO RELATED APPLICATION

This application claims the benefit of U.S. Patent Application No. 63/481,269, filed on Jan. 24, 2023, which is incorporated by reference herein in its entirety.

### TECHNICAL FIELD

This disclosure relates to the sol-gel synthesis of phosphorus-containing MAX phase materials, including microwires, thick films, and microspheres, and the resulting microstructures.

### BACKGROUND

MAX phase materials have ceramic properties (e.g., high temperature resistance, fatigue resistance, damage tolerance) and metallic properties (e.g., electrical and thermal conductivity), and can be used, for example, as coatings for materials under extreme conditions. MAX phase materials generally have a composition represented by Mₙ₊₁AXₙ, where M is a transition metal, A is an A group element (typically IIIA or IVA), each X is independently carbon or nitrogen, and n is 1, 2, 3, or 4. MAX phase materials have been synthesized by solid state methods, such as hot isostatic pressing, spark plasma sintering, and simple high temperature furnace syntheses.

### SUMMARY

This disclosure generally relates to the synthesis of the MAX phase V₂PC using a versatile sol-gel method and the resulting materials. The sol-gel method allows the use of water-soluble metal salts for the source of vanadium and phosphoric acid for the source of phosphorus. A variety of organic materials are suitable as sources of carbon, including starches, sugars, and acidic chelating agents.

In a first general aspect, making a MAX phase material having a composition represented by V₂PC includes combining a transition metal component, a phosphorus component, and a carbon component to yield a mixture, heating the mixture to yield a gel, and heating the gel to yield the MAX phase material. wherein the MAX material has a composition represented by V₂PC. The transition metal component includes vanadium, the phosphorus component includes phosphoric acid, and the carbon component includes an organic compound. The gel can be formed into a film, a microsphere, or a microwire.

Implementations of the general aspect may include one or more of the following features.

The transition metal component can include ammonium metavanadate, vanadium (III) chloride, or both. The carbon component can include a carbohydrate, such as a starch (e.g., amylum, dextran, or chitosan) or a sugar (e.g., D-glucose). In some cases, the carbon component comprises an acidic chelating agent, such as citric acid. In certain cases, a molar ratio of the transition metal component to the phosphorus component is approximately 2 to 1.

Heating the mixture to yield a gel typically includes heating the mixture to a temperature below 150° C. Heating the mixture to a temperature below 150° C. can include heating the gel to a temperature of 140° C., and decreasing the temperature to 80° C. Heating the gel to yield the MAX phase material can include heating the gel in the absence of oxygen to a temperature below 1100° C. Heating the gel in the absence of oxygen to a temperature below 1100° C. can include increasing the temperature at a rate of 2° C. per minute to 950° C., holding the temperature at 950° C. for 5 hours, and cooling to room temperature.

Some implementations include washing the MAX phase material with acid, grinding the MAX phase material, or both.

In a second general aspect, a MAX phase structure includes a film, microsphere, or microwire having a composition represented by V₂PC.

In a third general aspect, a device includes the MAX phase structure of the second general aspect.

Advantages of the sol-gel synthetic method disclosed here include the use of relatively safe phosphoric acid as the source of phosphorus. Conventional solid-state synthetic methods use toxic red phosphorous and ultra-high temperatures, and produce low yields of the target product. The sol-gel method disclosed herein provides versatility that allows variation of synthetic parameters and reactants to maximize product yields and purity. The sol-gel synthetic methods typically produce V₂PC in higher yields than conventional solid state methods. Through the use of various metal precursor salts and acids, this method of synthesis allows for more accuracy in targeting specific phase compositions in the V-P-C ternary phase family. The method provides a processability that allows formation of the MAX phases into thin films, microspheres, wires, and other forms for applications in areas including electronics, refrigeration, and drug delivery.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic of a sol-gel synthesis method described herein for making the MAX phase material V₂PC.

FIG. 2A shows X-ray powder diffraction data of V₂PC prepared with citric acid as the carbon source. FIG. 2B shows X-ray powder diffraction data of V₂PC prepared with citric acid as the carbon source after a 13 day acid-wash. FIGS. 2C and 2D show refined X-ray pair distribution function (PDF) data for V₂PC prepared at 950° C. and Cr₂GaC prepared at 1050° C., respectively.

### DETAILED DESCRIPTION

This disclosure relates to sol-gel synthesis of the MAX phase V₂PC and the resulting functional materials. The sol-gel synthesis process uses water soluble vanadium salts as the source of the transition metal component M, phosphoric acid as the source of phosphorus for the A group element, and organic carbon components as the source for carbon represented by X.

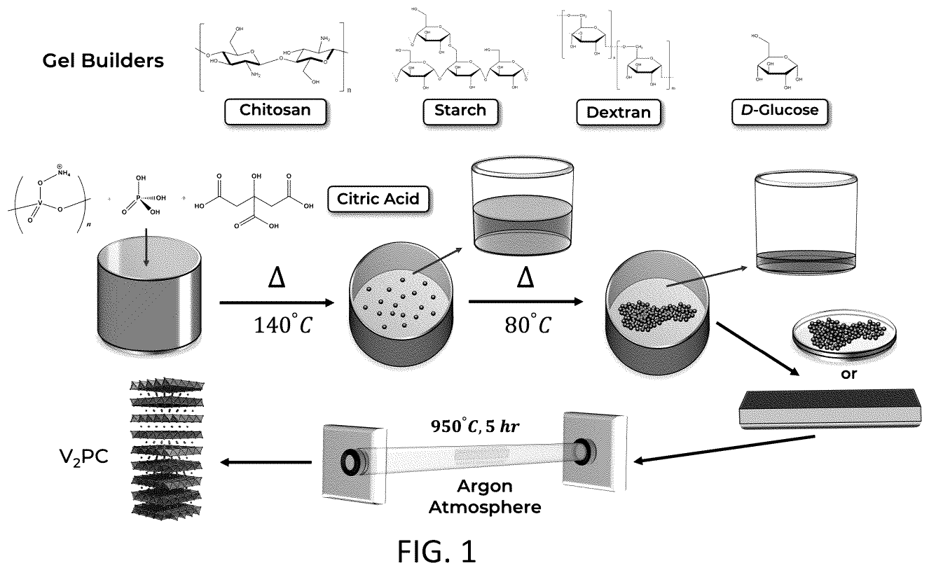

FIG. 1 depicts a sol-gel synthesis to make the MAX phase material V₂PC. A transition metal component including vanadium, a phosphorus component, and a carbon component are combined to form a mixture. Suitable transition metal components including vanadium include ammonium metavanadate and vanadium (III) chloride. An example of a phosphorus component is phosphoric acid. Suitable carbon components include carbohydrates (e.g., starches and sugars) and chelating agents. Suitable starches include amylum, dextran, and chitosan. An example of a suitable sugar is D-glucose. An example of a suitable chelating agent is citric acid.

The mixture including the transition metal component, the phosphorus component, and the carbon component is heated to a first temperature to partially boil off solvent. The heat is then decreased to a second temperature and stirred to yield a gel. The gel is heated to a third temperature in the absence of oxygen to yield a MAX phase material. Although the synthesis depicted in FIG. 1 includes a first temperature of 140° C., a second temperature of 80° C., and a third temperature of 950° C., other temperatures are possible. Similarly, although the synthesis depicted in FIG. 1 includes heating at the third temperature for 5 hours under an argon atmosphere, other durations and inert atmospheres can be used. After removal, the MAX phase material V₂PC can be ground to form a powder.

### EXAMPLES

Sol-gel synthesis of V₂PC MAX phase. Adjusting the stoichiometry of the M and A element within V₂PC at 2:1, starting reagents including ammonium metavanadate (Acros Organics, 99.5%, NH₄VO₃), a vanadium source, and phosphoric acid (Beantown Chemical, 85 wt. %, H₃PO₄), a phosphorus source, were chosen because of their case of solubility in water. To achieve the desired stoichiometry of 2:1 V to P and yielding ultimately a 250 mg bulk sample, a 100 mL stock solution of 0.4383 M phosphoric acid was made. 0.4037 g (3.45 mmols, 2 eq.) of ammonium metavanadate were weighed out in air and transferred to a beaker. 3.93 mL (1.72 mmols, 1 eq.) of 0.4383 M phosphoric acid were also transferred to the beaker, together with 5 mL of water. Mixing of the reagents with no heating was performed to minimize the risk of any generation of vanadium phosphate oxide intermediates. 1.757 g (9.15 mmols, 5.3 eq) of citric acid (Alfa Aesar, 99+%), a carbon source, was weighed out in air. Before citric acid was added to the 2:1 V:P solution, an additional 27% (1.06 mL, 0.46 mmols, or 0.27 eq) of phosphoric acid was added to mitigate the production of side phases in the final product. The vanadium phosphorus solution was mixed a second time. Citric acid was then added to the V-P solution and the temperature was increased to 140° C. Heating of the solution was continued until a large portion of the solvent was boiled off. The heat was then decreased to 80° C. With more heating at 80° C. combined with stirring. gelation occurred. Once gelation of the desired viscosity was achieved, the temperature was reduced to room temperature. The viscous dark blue gel was then transferred to an alumina boat and placed into a quartz half ampoule. The gel housed in the quartz ampoule was transferred to a horizontal 3-zone tube furnace (Carbolite, model EST). Ultra high purity (UHP) Ar was flowed into the horizontal tube furnace held at 60° C. and left to sufficiently purge the environment for 30 minutes. The temperature was then increased from 60° C. to 950° C. at a rate of 2° C. per minute. The temperature of 950° C. was held for 5 hours. The temperature was then decreased to room temperature passively. The calcined product was recovered and grinded utilizing a mortar and pestle for further analysis.

Synthesis of V₂PC is also possible using other carbon sources such as a dextran, starch (e.g., amylum), D-glucose, and chitosan. The synthesis methods for dextran, starch, and D-glucose are analogous to the methods for citric acid. A 200 mg synthesis of D-glucose was performed using 0.3230 g (2.76 mmols, 2 eq.) of ammonium metavanadate, 1.889 mL (1.93 mmols, 1.4 eq.) of 1.02305 M phosphoric acid, and 1.865 g (10.4 mmols, 7.5 eq) of D-glucose. Heating conditions in the furnace remained the same as described for citric acid. The yield for this synthesis method was of 63% V₂PC MAX phase.

Dextran and starch synthesis allow for precise molar determination of the 2:1 V:P ratio. An average of the molar amounts of the carbon content can be ascertained. Therefore, the amounts of dextran and starch used in the synthesis will have variation in the amounts of carbon actually being introduced to the precursor gel. Dextran synthesis used 0.3229 g (2.76 mmols, 2 eq.) of ammonium metavanadate, 1.349 mL (1.38 mmols, 1 eq.) of 1.02305 M phosphoric acid, and 575 mg of dextran. These amounts produced a yield of 83% MAX phase. V₂PC synthesis using starch as a carbon source used 0.3229 g (2.76 mmols, 2 eq.) of ammonium metavanadate, 1.349 mL (1.38 mmols, 1 eq.) of 1.02305 M phosphoric acid, and 500 mg of starch where 62% MAX phase was produced.

Chitosan synthesis differs from the other carbon source syntheses in its preparation and choice of metal precursors. Rather than a combustion of precursor gel, thin films were produced and then subsequently combusted. 100 mL of 0.2 M acetic acid was prepared and placed in a 200 ml beaker. 1 g of Medium Molecular Weight (M.M.W.) chitosan was added to the acetic acid solution. The resulting mixture was stirred vigorously until complete homogenization. 10 mL of the chitosan gel was dispensed into a 50 mL beaker. Again, adjusting the V:P ratio at 2:1, vanadium (III) chloride and phosphoric acid were utilized as the respective vanadium and phosphorus sources. Ammonium metavanadate was not used in this case due to the facility of chitosan forcing the vanadium phosphate intermediates generated from the metavanadate ions and phosphoric acid out of solution as a precipitate. Vanadium (III) chloride was utilized as an alternative choice. Two 10 mL solutions of 0.5 M (0.7865 g or 5 mmols in water) vanadium (III) chloride and 0.25 M phosphoric acid were made. Taking 0.5 mL from each respective stock solution and dispensing into the 10 mL chitosan combined to a 1 mL total of 0.75 M (2:1, V:P added). The greenish gel was stirred for about 10-20 mins, cast onto a Petri dish, and then dried overnight at 35° C. The greenish thin film was then further calcined using the same temperature profile that was utilized in the dextran, starch, D-glucose, and citric acid synthesis. Yields for the chitosan V₂PC MAX phase synthesis were approximately 39-40%.

The chitosan sol-gel synthesis of the V₂PC MAX phase included the production of a thin film that is then subsequently combusted with the same temperature profile utilized by the citric acid, dextran, starch, and D-glucose syntheses. The films, pre-combustion are green in color, which would suggest that V³⁺ ions are present in the gel that is then transformed into a thin film via overnight drying. The films post-combustion were crystalline and blackish in color.

The dextran gel when wet was brown in color and was about the same viscosity that is received from the blue citric acid variation of the MAX phase. When dried, the dextran samples transformed into a waxy solid. As more carbon content in the form of dextran was added, the color shifted to black. Less additional dextran added yielded green colored solid. In both scenarios of a wet or dried gel the products were rather crystalline, which indicates that taking the gel in a wet state versus a dried state may not impact product yields or MAX phase %.

The starch wet gel variations had a higher viscosity relative to the other gel variations. They were similar in color to the dextran gels, but the brown was much more vibrant. The wet starch gel also had a tendency to dry much more quickly than any other carbon source variations. Drying the starch gels yielded another waxy solid that felt almost leathery to the touch. When combusting the dried gel there was a noticeable shift in intensities of side phases, namely the V₅P₃N/C phase. This is the main species that coexists with the MAX phase if the stoichiometry is not adjusted according to the V-P-C phase diagram. Its appearance was slightly minimized if the amount of starch added matched what is mentioned in Table 1. The wet gel variation of the starch synthesis did not reproduce this effect in decreasing the presence of side phases.

TABLE 1
A list of the precursors, synthesis conditions,
and ratios of the five different carbons
sources used in the sol-gel synthesis of V2PC.

| Carbon | | Synthesis | Ratios/Amounts |
|---|---|---|---|
| Source | Precursors | Conditions | (V-P-C) |
| Citric | NH₄VO₃ | Wet/Dry Gel | 2-1.27-5.3 |
| Acid | and H₃PO₄ | Combustion | |
| Dextran | NH₄VO₃ | Wet/Dry Gel | 2-1-(575 mg) |
| | and H₃PO₄ | Combustion | |
| Starch | NH₄VO₃ | Wet/Dry Gel | 2-1-(500 mg) |
| | and H₃PO₄ | Combustion | |
| D- | NH₄VO₃ | Wet/Dry Gel | 2-1.4-7.5 |
| Glucose | and H₃PO₄ | Combustion | |
| Chitosan | VCl₃ and | Thin Film | 2-1-(10 mL) |
| | H₃PO₄ | Combustion | |

The D-glucose gel variation was a deep black color after sufficient mixing and boiling off of solvent. With less D-glucose added to the system, the gel appeared slightly green coupled with black. Drying the D-glucose gel generated a sweet aroma and transformed the black-greenish gel into a brownish solid. Combusting both the wet and dry cased of the gels gave a crystalline material. An amorphous graphite was produced as revealed by Powder X-ray Diffraction. The chitosan synthesis produced a greater amount of amorphous graphite compared with the D-glucose synthesis.

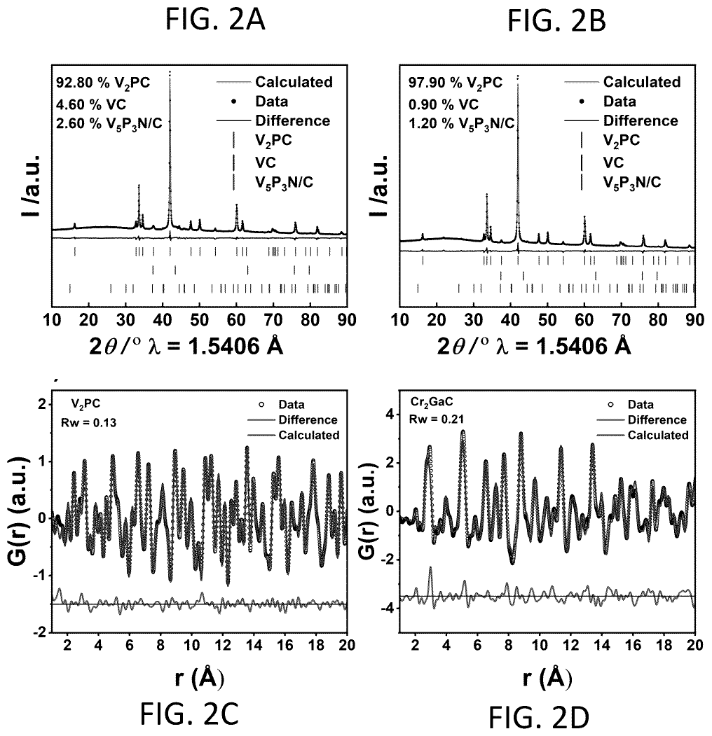

Analysis of V₂PC MAX phase. The phase diagram of the ternary V-P-C system indicates that V₂PC exists within a small phase homogeneity range. Because of this, phases such as the nonstoichiometric V₅P_{2.83}C_{0.5}, binary VC, and even graphitic species (C) have a greater chance to crystallize compared to the target phase V₂PC. Sol gel-based methods offer more synthetic parameters to be varied to mitigate the production of off-target side phases, in contrast to solid-state methods, which can typically vary only the V-P-C stoichiometry and temperature profiles. The X-ray powder diffraction data of the as-prepared as well as acid-washed products prepared with citric acid are shown in FIGS. 2A and 2B, respectively. In both cases, the MAX phase is the main phase while VC and V₅P₃N/C phases are identified as minor side phases that can almost completely be removed by the acid wash.

V₅P₃N/C formation becomes possible because ammonium diffraction peaks of this phase, the Miller indices of (211), (300), and (112), correspond to 2θ angles of 44.5°, 45.6°, and 46.3°. Comparatively with the nonstoichiometric phase V₅P_{2.83}C_{0.5}, 2θ angles of 44.0°, 45.2°, and 45.8° are observed which are almost identical with the stoichiometric V₅P₃N. Distinguishing between these two phases can be difficult. To avoid convolution, it was advantageous that both these phases in some capacity be incorporated into the Rietveld refinements of the as-synthesized and acid-washed samples. To acknowledge the presence of either phase or even a solid solution of the two, the database peak positions of V₅P₃N/C were included.

FIGS. 2C and 2D show refined X-ray pair distribution function (PDF) data for V₂PC prepared at 950° C. and Cr₂GaC prepared at 1050° C., respectively. The remaining low-r peaks confirm the expected atom-atom distances for the MAX phase structure: for Cr₂GaC (FIG. 2D), 2.0, 2.5, and 2.8 A correspond to Cr—C, Cr—Ga (2.65 A), and Cr—Cr, respectively. For V₂PC (FIG. 2C), 2.0, 2.4, and 2.8 A correspond to V-C, V-P, and V-V, respectively. The crystalline model used in the Rietveld refinement provides a good description of the entire PDF and is therefore a good description of the local and average structure of the synthesized V₂PC. This shows that there is no local disordering in the formed material and that the reaction temperature of 950° C. is advantageous for sample crystallinity.

An advantage of these sol gel-based syntheses is that the ingredients can readily be varied. All chosen gel builders/carbon sources (e.g., citric acid, dextran, starch, D-glucose, and chitosan) led to the formation of the target compound V₂PC, however, with some differences in yields. The effects of the carbon source on the product composition as determined by analysis of the X-ray powder diffraction data are summarized in Table 2. The citric acid-based sol-gel synthesis of V₂PC readily produces 90+% MAX phase utilizing optimized synthesis parameters (as-prepared samples). Alternative carbon source yields are outlined again in Table 2. Washing the samples, independent of the carbon source, leads to removal of side phases with an increase in MAX phase yield as shown in Table 3. The crystallinity of the products after acid washings is not diminished upon exposure for longer periods of time.

TABLE 2
Composition of as-prepared samples
using different carbons ources obtained
by Rietveld refinements of the XRD data

| carbon source | | | | |
|---|---|---|---|---|
| (wt %) | V₂PC | VC | V₅P_{2.83}C_{0.5} | C |
| citric acid | 90.1 | 4.3 | 5.6 | |
| dextran | 83.4 | 12.8 | 3.75 | |
| starch | 62.6 | 16.3 | 18.9 | 2.1 |
| D-glucose | 64.0 | 8.0 | 10.2 | 17.0 |
| chitosan | 37.8 | 47.0 | 6.9 | 8.0 |

TABLE 3
Composition of the acid-washed samples
prepared with different carbon sources obtained
by Rietveld refinements of the XRD data

| carbon | (wt %) | | | |
|---|---|---|---|---|
| source | V₂PC | VC | V₅P_{2.83}C_{0.5} | C |
| citric acid | 93.5 | 2.6 | 3.9 | |
| dextran | 84.5 | 11.0 | 4.5 | |
| starch | 76.8 | 11.7 | 10.2 | 1.4 |
| D-glucose | 66.0 | 7.0 | 6.5 | 21.0 |
| chitosan | 38.0 | 45.0 | 3.2 | 14.0 |

Scanning electron microscope (SEM) images and energy dispersive spectroscopy (EDS) analysis of V₂PC made with citric acid as-prepared, acid-washed with H₂SO₄ exposure for 24 h, and acid-washed with H₂SO₄ exposure for 13 days were conducted. The as-synthesized sample exhibits a very smooth surface. The 24 hour acid-washed sample shows signs of the etching process with craters and more rugged surfaces, which is the result of the removal of side phases. After a prolonged acid exposure of 13 days, relatively smooth surfaces were observed. The morphologies when utilizing other carbon sources do not differ significantly from the structures obtained with citric acid.

To gain insights into phase stability and electronic structure of the MAX phase, the formation energy and band structure of V₂PC were further investigated by the density functional (DFT) method. The optimized lattice constants agree well with the experimental values as listed in Table 4. Furthermore, the formation energy of this phase is observed as thermodynamically formable. The calculated value is −0.712 eV/atom. The band structure of the V₂PC, displaying the phase as a metallic system, shows hole and electron bands crossing the Fermi level along the whole Brillouin zone. In addition, the electronic states around the Fermi level are dominated by the 3d orbitals of V atoms, with a small contribution from the phosphorus and carbon p orbitals.

TABLE 4
Lattice Parameter Comparison
of the V₂PC MAX Phase

| Lattice | | |
|---|---|---|
| Parameters | Exptl. | Computed |
| a | 3.078 | 3.071 |
| c | 10.924 | 10.900 |

Powder X-ray Diffraction. All as-synthesized products were thoroughly ground with an agate mortar pestle and mounted on top of a flat cylindrical Si low background stage. The X-ray powder diffractograms were recorded using a Bruker D2 Phaser (2^{nd} Generation) powder X-ray diffractometer that utilizes Ni-filtered Cu Kα radiation (λ=1.5406). Data collection was performed at room temperature with 2θ ranges extending from 10°-90° and a step-size of 0.05°. The experimental diffractograms were matched with theoretical profiles and patterns for accurate phase determination. Analysis of the Bragg peaks and percentages of existing phases were carried out using a Rietveld refinement with the assistance of Topas. For the most accurate lattice parameter determination, an internal standard of LaB₆ was mixed into a portion of the as-synthesized samples and another separate refinement was performed. Ample amounts of the standard, LaB₆, and the bulk sample were added so that the characteristic peaks of the standard and sample were of comparable intensities. The lattice parameters of V₂PC generated from the standard were then applied to a refinement without the standard and fixed.

Total scattering data were collected at Deutsches Elektronen Synchrotron (DESY), Hamburg, Germany at beamline P02.1. The samples were loaded into a 1 mm Kapton capillary and measured with a wavelength of λ=0.2071 Å. The X-ray Pair Distribution Functions (PDFs) were obtained using PDFgetX3 in XPDFsuite. The X-ray scattering signal from an empty Kapton tube was used for background subtraction. The X-ray PDF of crystalline V₂PC and Cr₂GaC was refined using PDFgui. In the refinements of both MAX phases (V₂PC and Cr₂GaC), the unit cell parameters, isotropic atomic displacement parameters, scale factor, and atomic positions were all refined and converged to reasonable values. Crystallite size was explained by spherical dampening using a parameter known as the SPdiameter. V₂PC and Cr₂GaC were also both refined in the space group P₆₃/mmc.

Electron microscopy. Analysis of the microstructure and composition was performed using an Auriga-Zeiss FIB SEM equipped with an Oxford Instruments SDD detector (Ultim MAX). A standard aluminum stage holder was covered with carbon tape serving as a way to fasten as-synthesized and acid-washed variations of samples to the holder surface. The beam current was set at a 20 keV accelerating potential. Multiple sites of the bulk samples were analyzed at varying magnifications (ranging from 1K-20K magnification).

Electronic Structure Calculations. All first-principles calculations were performed using the Vienna Ab initio Simulation Package (VASP) based on density functional theory (DFT). This code implements the projector augmented wave (PAW) method. The wave functions are expanded on a plane-wave basis with a 15×15×5 Monkhorst-Pack k-sampling grid and cutoff energy of 550 eV. The precision of total energy convergence for the self-consistent field (SCF) calculations was as high as 10⁻⁶ eV. All structures are fully optimized until the maximal Hellmann-Feynman force is less than 10⁻³ eV/Å.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of making MAX phase material, the method comprising:
combining a transition metal component, a phosphorus component, and a carbon component to yield a mixture, wherein the transition metal component comprises vanadium, the phosphorus component comprises phosphoric acid, and the carbon component comprises an organic compound;
heating the mixture to yield a gel; and
heating the gel to yield the MAX phase material, wherein the MAX material has a composition represented by V₂PC.

2. The method of claim 1, wherein the transition metal component comprises ammonium metavanadate.

3. The method of claim 1, wherein the transition metal component comprises vanadium (III) chloride.

4. The method of claim 1, wherein the carbon component comprises a carbohydrate.

5. The method of claim 4, wherein the carbohydrate comprises a starch.

6. The method of claim 5, wherein the starch comprises amylum, dextran, or chitosan.

7. The method of claim 4, wherein the carbohydrate comprises a sugar.

8. The method of claim 7, wherein the sugar comprises D-glucose.

9. The method of claim 1, wherein the carbon component comprises an acidic chelating agent.

10. The method of claim 9, wherein the acidic chelating agent comprises citric acid.

11. The method of claim 1, wherein a molar ratio of the transition metal component to the phosphorus component is approximately 2 to 1.

12. The method of claim 1, wherein heating the mixture to yield a gel comprises heating the mixture to a temperature below 150° C.

13. The method of claim 12, wherein heating the mixture to a temperature below 150° C. comprises:
heating the gel to a temperature of 140° C.; and
decreasing the temperature to 80° C.

14. The method of claim 1, wherein heating the gel to yield the MAX phase material comprises heating the gel in the absence of oxygen to a temperature below 1100° C.

15. The method of claim 14, wherein heating the gel in the absence of oxygen to a temperature below 1100° C. comprises:
increasing the temperature at a rate of 2° C. per minute to 950° C.;
holding the temperature at 950° C. for 5 hours; and
cooling to room temperature.

16. The method of claim 1, wherein the gel is formed into a film.

17. The method of claim 1, further comprising washing the MAX phase material with acid.

18. The method of claim 1, further comprising grinding the MAX phase material.

19. A MAX phase structure comprising:
a film, microsphere, or microwire having a composition represented by V₂PC.

20. A device comprising the MAX phase structure of claim 19.
